(19) United States
(12) Patent Application Publication
(10) Pub. No.: US 2015/0142861 A1
(43) Pub. Date: May 21, 2015

(54) STORAGE UTILITY NETWORK

(71) Applicant: The Weather Channel, LLC, Atlanta, GA (US)

(72) Inventor: Sathish Gaddipati, Atlanta, GA (US)

(21) Appl. No.: 14/539,223

(22) Filed: Nov. 12, 2014

Related U.S. Application Data
(60) Provisional application No. 61/903,650, filed on Nov. 13, 2013.

(51) Int. Cl. G06F 17/30

(52) U.S. Cl. CPC G06F 17/30091
USPC 707/812

(57) ABSTRACT

A storage utility network that includes an ingestion application programming interface (API) mechanism that receives requests from data sources to store data, the requests each containing an indication of a type of data to be stored; at least one data processing engine that is configured to process the type of data, the processing by the at least one data processing engine transforming the data to processed data having a format suitable for consumer use; a plurality of databases that store the processed data and provide the processed data to consumers; and a pull API mechanism that is called by the consumers to retrieve the processed data.

### CROSS-REFERENCE TO RELATED APPLICATION

This application claims priority to U.S. Provisional Patent Application No. 61/903,650, filed Nov. 13, 2013, entitled “STORAGE UTILITY NETWORK,” which is incorporated herein by reference in its entirety.

### BACKGROUND

The ingestion and storage of large volumes of data is very inefficient. For example, to provide access to large amounts of data, multiple data centers are often used. However, this results in high operating costs and a lack of a centralized scalable architecture. In addition, there is often duplication and inconsistencies of data across the multiple data centers. Such datacenters often do not provide visibility of data access, making it difficult for clients to retrieve the data, which results in each of the multiple data centers operating as an island, without full knowledge of the other datacenters. Still further, when conventional datacenters process large amounts of data, latencies are introduced that may adversely affect the availability of the data such that it may no longer be relevant under some circumstances.

### SUMMARY

Disclosed herein are systems and methods for providing a scalable storage network. In accordance with some aspects, there is provided a storage utility network that includes an ingestion application programming interface (API) mechanism that receives requests from data sources to store data, the requests each containing an indication of a type of data to be stored; at least one data processing engine that is configured to process the type of data, the processing by the at least one data processing engine transforming the data to processed data having a format suitable for consumer use; a plurality of databases that store the processed data and provide the processed data to consumers; and a pull API mechanism that is called by the consumers to retrieve the processed data.

In accordance with other aspects, there is provided a method of storing and providing data. The method includes receiving a request at an ingestion application programming interface (API) mechanism from data sources to store data, the requests each containing an indication of a type of data to be stored; processing the data at a data processing engine that is configured to process the type of data to transform the data to processed data having a format suitable for consumer use; storing the processed data at one of a plurality of databases that further provide the processed data to consumers; and receiving a call from a consumer at a pull API mechanism to retrieve the processed data

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example Storage Utility Network (SUN) architecture in accordance with the present disclosure;

FIG. 2 illustrates an example data ingestion architecture;

FIG. 3 illustrates an example data processing engine (DPE);

FIG. 4 illustrates an example operation flow of the processes performed to ingest input data received by the SUN of FIG. 1;

FIG. 5 illustrates example client access to the storage utility network using a geo-location based API; and

FIG. 6 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

The present disclosure is directed to a storage utility network (SUN) that serves a centralized source of data injection, storage and distribution. The SUN provides a non-blocking data ingestion, pull and push data service, load balanced data processing across data centers, replication of data across data centers, use of memory based data storage (cache) for real time data systems, low latency, easily scalability, high availability, and easy maintenance of large data sets. The SUN may be geographically distributed such that each location stores geographic relevant data to speed processing. The SUN is scalable to billions of requests for data a day while serving data at a low latency, e.g., 10 ms-100 ms. As will be described, the SUN 100 is capable of metering and authentication of API calls with low latency, processing multiple TBs of data every day, storing petabytes of data, and having a flexible data ingestion platform to manage hundreds of data feeds from external parties.

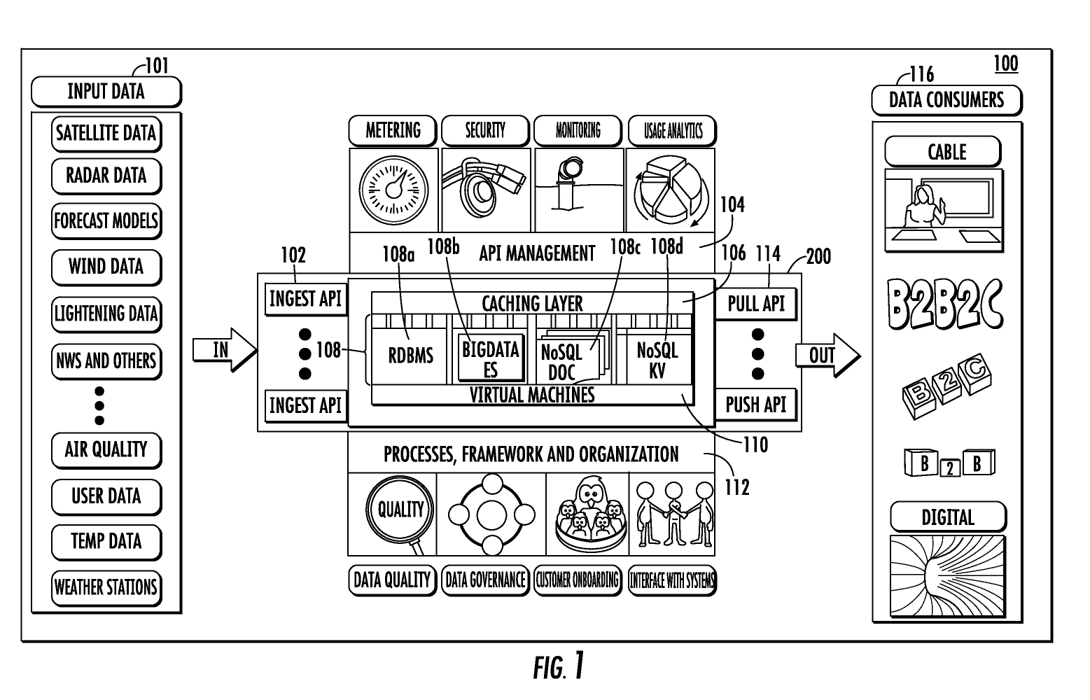

With the above overview as an introduction, reference is now made to FIG. 1, which illustrates an example implementation of the storage utility network (SUN) 100 of the present disclosure. The SUN 100 includes an ingestion API mechanism 102 that receives input data 101 from various sources, an API management component 104; a caching layer 106; data storage elements 108a-108d; virtual machines 110; a process, framework and organization layer 112; and a pull API mechanism 114 that provides output data to various data consumers 116. The data consumers 116 may be broadcasters, cable systems, web-based information suppliers (e.g., news and weather sites), and other disseminators of information or data.

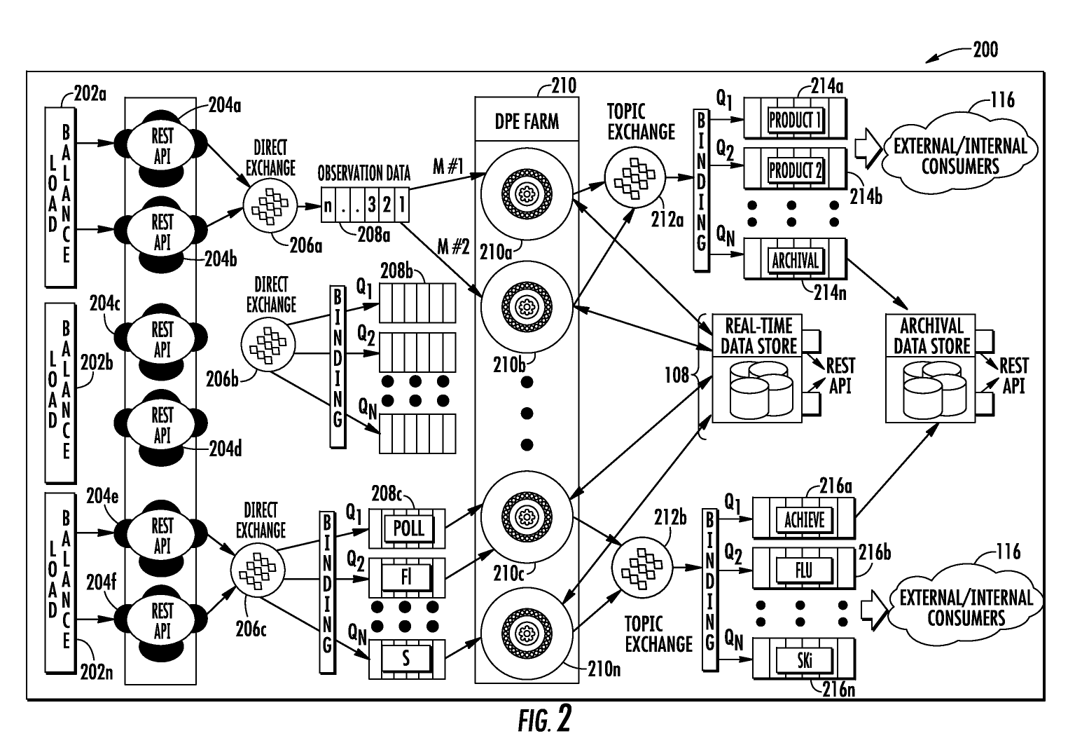

The ingestion API 102 is exposed by the SUN 100 to receive requests at, e.g., a published Uniform Resource Identifier (URI), to store data of a particular type within the SUN 100. Additional details of the ingestion API 102 are described with reference to FIG. 2. The API management component 104 is provided to authenticate, meter and throttle application programming interface (API) requests for data stored in or retrieved from the SUN 100. Non-limiting examples of the API management component 104 are Mashery and Layer 7. The API management component 104 also provides for customer onboarding, enforcement of access policies and for enabling services. The API management component 104 make the APIs accessible to different classes end users by applying security and usage policies to data and services. The API management component 104 may further provide analytics to determine usage of services to support business or technology goals. Details of the API management component 104 are disclosed in U.S. Patent Application No. 61/954,688, filed Mar. 18, 2014, entitled “LOW LATENCY, HIGH PAYLOAD, HIGH VOLUME API GATEWAY,” which is incorporated herein by reference in its entirety.

The caching layer 106 is an in-memory location that holds data received by the SUN 100 and server data to be sent to the data consumers 116 (i.e., clients) of the SUN 100. The data storage elements 108 may include, but are not limited to, a relational database management system (RDBMS) 108a, a big data file system 108b (e.g., Hadoop Distributed File System (HDFS) or similar), and a NoSQL database (e.g., a NoSQL Document Store database 108c, or a NoSQL Key Value database 108d). As will be described below, data received by the ingestion API 102 is processed and stored in a non-blocking fashion into one of the data storage elements 108 in accordance with, e.g., a type of data indicated in the request to the ingestion API 102.

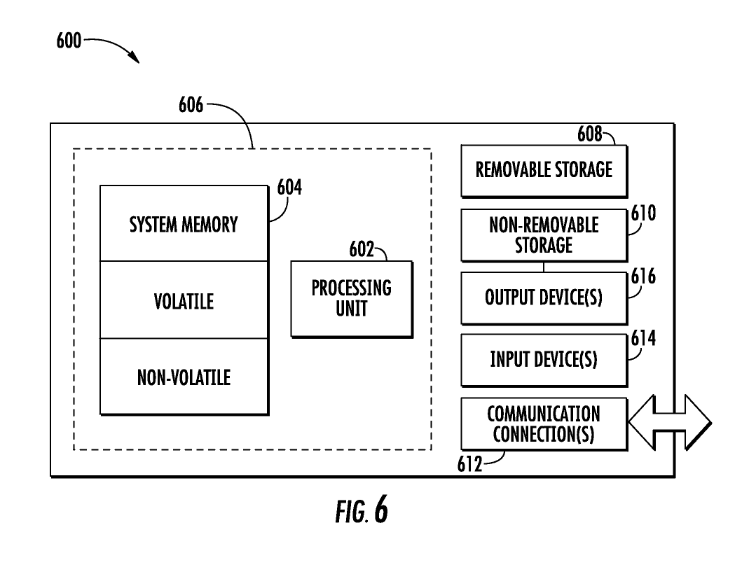

In accordance with the present disclosure, elements within the SUN 100 are hosted on the virtual machines 110. For example, data processing engines 210 (FIG. 2) may be created and destroyed by starting and stopping the virtual machines to retrieve inbound data from the caching layer 106, examine the data and process the data for storage. As understood by one of ordinary skill in the art, the virtual machines 110 are software computers that run an operating system and applications like a physical computing device. Each virtual machine is backed by the physical resources of a host computing device and has the same functionality as physical hardware, but with benefits of portability, manageability and security. For example, virtual machines can be created and destroyed to meet the resource needs of the SUN 100, without requiring the addition of physical hardware to meet such needs. An example of the host computing device is described with reference to FIG. 6

The process, framework and organization layer 112 provides for data quality, data governance, customer onboarding and an interface with other systems. Data services governance includes the business decisions for recommending what data products and services should be built on the SUN 100, when and what order data products and services should be built, and distribution channels for such products and services. Data quality ensures that the data processed by the SUN 100 is valid and consistent throughout.

The pull API mechanism 114 is used by consumers to fetch data from the SUN 100. Similar to the ingestion API 102, the pull API mechanism 114 is exposed by the SUN 100 to receive requests at, e.g., a published Uniform Resource Identifier (URI), to retrieve data associated with a particular product or type that is stored within the SUN 100.

The SUN 100 may be implemented in a public cloud infrastructure, such as Amazon Web Services, Microsoft Azure, Google Cloud Platform, or other in order to provide high-availability services to users of the SUN 100.

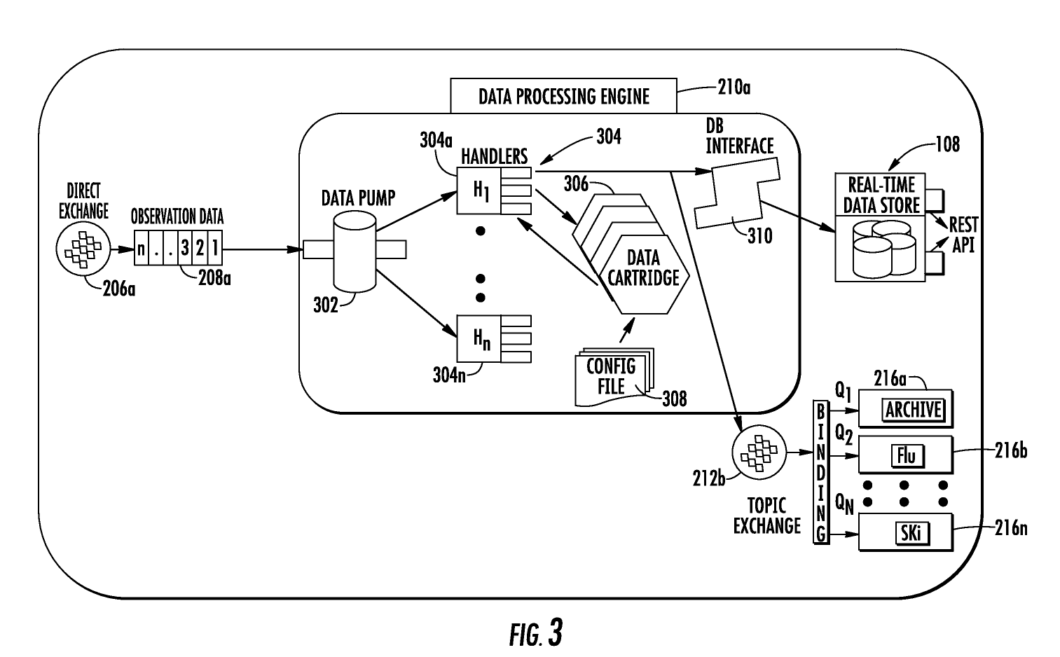

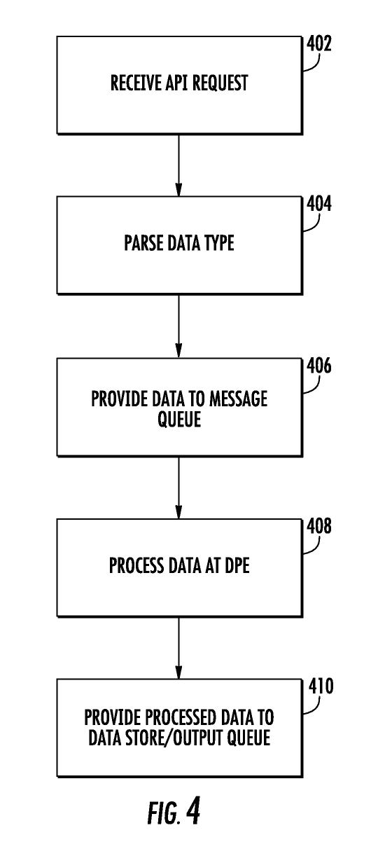

With reference to FIGS. 2-4, operation of the SUN 100 will now be described in greater detail. In particular, FIG. 2 illustrates an example data ingestion architecture 200 within the SUN 100. FIG. 3 illustrates an example data processing engine (DPE) 210a-210n. FIG. 4 illustrates an example operation flow of the processes performed to ingest input data received by the SUN 100.

As noted above, the data ingestion architecture 200 features a non-blocking architecture to process data received by the SUN 100. The data ingestion architecture 200 includes load balancers 202a-202n that distribute workloads across the computing resources within the architecture 200. For example, when an input data source calls the ingestion API 102 that is received by the SUN 100 (at 402), the load balancers 202a-202n determine which resources associated with the called API are to be utilized in order to minimize response time associated with the components in the data ingestion architecture 200. Included in the call to the ingestion API 102 is information about the type of data that is to be communicated from the input data source to the data ingestion architecture 200. This information may be used by the load balancers 202a-202n to determine which one of Representational State Transfer (REST) APIs 204a-204n will provide programmatic access to write the input data into the data ingestion architecture 200 (at 404).

The REST APIs 204a-204n provide an interface to an associated direct exchange 206a-206n to communicate data into an appropriate message queue 208a-208c (at 406) for processing by a data processing engine (DPE) farm 210 (at 408). In accordance with aspects of the present disclosure, each DPE 210a-201n may be configured to process a particular type of the input data. For example, the input data may be observational data that is received by REST API 204a or 204b. With that information, the observational data may be placed in the queue 208a of the DPE 210a that is responsible for processing observational data. As such, the SUN 100 attempts to route data in such a manner that each DPE is always processing data of the same type. However, in accordance with some aspects of the present disclosure, if a DPE 201a-210n receives data of an unknown type, the DPE 201a-210n will pass the data into a queue of another DPE 201a-210n that can process the data.

FIG. 3 illustrates an example data processing engine (DPE) 210a-210n. The DPE is a general purpose computing resource that receives the input data 101 and writes it to an appropriate data storage element 108. The DPE may be implemented in, e.g., JAVA and run on one of the virtual machines 110. On instantiation, the DPE notifies its associated message queue (e.g., message queue 208a for DPE 210a) that it is alive.

A data pump 302 within the DPE reads message from a queue and hands the message to handler 304. As shown, the handler 304 may be multi-threaded and include multiple handlers 304a-304n. The handler 304 sends the data to a data cartridge 306 for processing. The data cartridge 306 “programs” the functionality of the DPE in accordance with a configuration file 308. For example, there may be a separate data cartridge 306 for each data type that is received by the SUN 100. The data cartridge 306 formats the message into, e.g., a JavaScript Object Notation (JSON) document, determines Key and Values for each message, performs data pre-processing, transforms data based on business logic, and provides for data quality. The transformation of the data places it in a condition such that it is ready for consumption by one or more of the data consumers 116.

With reference to FIGS. 2 and 3, after the message is processed, the data cartridge 306 hands the processed message back to handler 304, which may then send the processed message (at 410) to a DB Interface 310 and/or a message queue exchange (e.g., 212b). For example, the DB Interface 310 may receive the message from the handler 304a and write it to a database (i.e. one of the data storage elements 108) in accordance with Key Values (or other information) defined in the message. Additionally or alternatively, a selection of the type of database may be made based on the type of data to be stored therein. Although not shown in FIG. 3, the DB Interface 310 is specific to particular type of database (e.g. Redis), thus there may be multiple DB Interfaces 310. Thus, the DB Interface 310 ensures the data is written to a database (e.g. Redis) in most optimal way from storage and retrieval perspective.

In another example, the handler 304a may communicate the data to the message queue exchange 212a/212b, which then queues the data into an appropriate output queue 2141-214n/216a-216n for consumption by data consumers 116. Thus, the data ingestion architecture 200 may make input data 101 available to data consumers 116 with very low latency, as data may be ingested, processed by the DPE farm 210, and output on a substantially real-time basis.

As an example of data processing that may be performed by the sun 100, the input data 101 may be gridded data such as observational data. Such data is commonly used in weather forecasting to create geographically specific weather forecasts that are provided to the data consumers 116. Such data is voluminous and time sensitive, especially when volatile weather conditions exist. The SUN 100 provides a platform by which this data may be processed by the data ingestion architecture 200 in an expeditious manner such that output data provided to the data consumers 116 is timely.

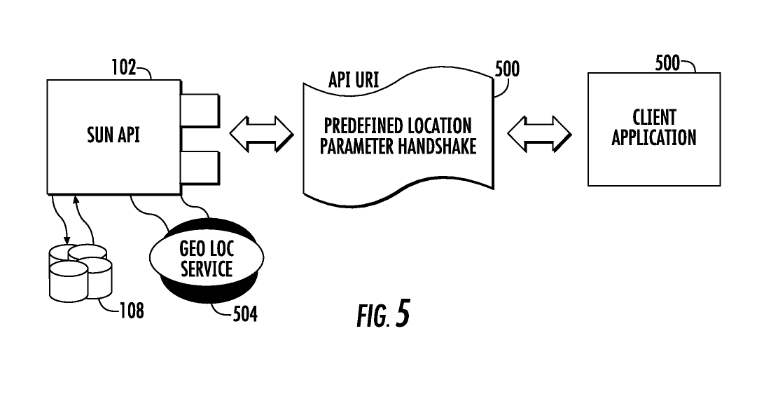

FIG. 5 illustrates an example client access to the storage utility network using a geo-location based API. In accordance with the present disclosure, a client application 500 may access the SUN 100 through a published Uniform Resource Identifier (URI) associated with the ingestion API 102 by passing pre-agreed location parameters 502. A Geo location service 504 may be provided as a geohashing algorithm. Geohashing algorithms utilize short URLs to uniquely identify positions on the Earth in order to make references to such locations more convenient. To obtain the geohash, a user provides an address to be geocoded, or latitude and longitude coordinates, in a single input box (most commonly used formats for latitude and longitude pairs are accepted), and performs the request.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of tangible computer readable media. Computer readable media can be any available tangible media that can be accessed by device 600 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A storage apparatus, comprising:
an ingestion application programming interface (API) mechanism that receives requests from data sources to store data, the requests each containing an indication of a type of data to be stored;
at least one data processing engine that is configured to process the type of data, the processing by the at least one data processing engine transforming the data to processed data having a format suitable for consumer use;
a plurality of databases that store the processed data and provide the processed data to consumers; and
a pull API mechanism that is called by the consumers to retrieve the processed data.

2. The apparatus of claim 1, further comprising an API management component that authenticates, meters and throttles the requests and the calls to the ingestion API mechanism and the pull API mechanism.

3. The apparatus of claim 2, wherein the ingestion API mechanism and the pull API mechanism are exposed by the storage apparatus to receive requests at respective Uniform Resource Identifiers (URI).

4. The apparatus of claim 1, wherein data received by the ingestion API is processed and stored in a non-blocking fashion into one of the databases in accordance with the type of data indicated in the request to the ingestion API mechanism.

5. The apparatus of claim 1, wherein the ingestion API mechanism further comprises load balancers that determine resources within the storage apparatus to be utilized in order to minimize response time to store the processed data in the databases.

6. The apparatus of claim 1, wherein the ingestion API mechanism places the data into a predetermined message queue in accordance with the type of data indicated in the request for processing by a respective data processing engine associated with the type of data.

7. The apparatus of claim 1, wherein the at least one data processing engine further comprises:
a data pump that reads message from a queue;
a handler that receives messages from the queue;
a data cartridge that configures the data processing engine to process the data from the handler to transform the data into the processed data;
a database interface that writes the processed data to a predetermined database among the plurality of databases; and
an exchange mechanism that provides processed data directly to the consumers,
wherein the predetermined database is selected based on the type of data to be stored therein.

8. The apparatus of claim 7, wherein if the respective data processing engine receives data of an unknown type, the respective data processing engine places the data into a queue of another of the at least one data processing engines that can process the data.

9. The apparatus of claim 1, wherein the data is gridded data provided by the data sources

10. The apparatus of claim 9, wherein the type of data is one of pollen data, satellite data, forecast models, wind data, lightening data, air quality data, user data, temperature data or weather station data.

11. A method of storing and providing data, comprising:
receiving a request at an ingestion application programming interface (API) mechanism from data sources to store data, the requests each containing an indication of a type of data to be stored;
processing the data at a data processing engine that is configured to process the type of data to transform the data to processed data having a format suitable for consumer use;
storing the processed data at one of a plurality of databases that further provide the processed data to consumers; and
receiving a call from a consumer at a pull API mechanism to retrieve the processed data.

12. The method of claim 11, further comprising authenticating, metering and throttling the requests and the calls to the ingestion API mechanism and the pull API mechanism using an API management component.

13. The method of claim 12, further comprising exposing the ingestion API mechanism and the pull API mechanism at respective Uniform Resource Identifiers (URI).

14. The method of claim 11, further comprising storing data in a non-blocking fashion into the one of the plurality databases in accordance with the type of data indicated in the request to the ingestion API mechanism.

15. The method of claim 11, further comprising providing load balances that determine resources within the storage apparatus to be utilized in order to minimize response time to store the processed data in the one of the plurality of databases.

16. The method of claim 11, further comprising placing the data into a predetermined message queue in accordance with the type of data indicated in the request for processing by a respective data processing engine associated with the type of data.

17. The method of claim 11, further comprising providing the data processing engine further with a data pump that reads message from a queue, a handler that receives messages from the queue, a data cartridge that configures the data processing engine to process the data from the handler to transform the data into the processed data, a database interface that writes the processed data to a predetermined database among the plurality of databases, and an exchange mechanism that provides processed data directly to the consumers,

18. The method of claim 17, further comprising:
determining if the respective data processing engine receives data of an unknown type; and
placing the data into a queue of another of the at least one data processing engines that can process the data.

19. The method of claim 11, wherein the data is gridded data provided by the data sources

20. The method of claim 19, wherein the type of data is one of pollen data, satellite data, forecast models, wind data, lightening data, air quality data, user data, temperature data or weather station data.
